(19) United States
(12) Patent Application Publication
(10) Pub. No.: US 2022/0136523 A1
(43) Pub. Date: May 5, 2022

(54) BILGE PUMP HAVING OUTSIDE SENSING SURFACE WITH RIBS

(71) Applicant: FLOW CONTROL LLC, Beverly, MA (US)

(72) Inventors: Francisco Jose CARRILLO WEBER, Chihuahua (MX); Humberto V. MEZA, Trabuco Canyon, CA (US)

(21) Appl. No.: 17/522,112

(22) Filed: Nov. 9, 2021

Related U.S. Application Data
(63) Continuation of application No. 15/888,648, filed on Feb. 5, 2018, now abandoned.
(60) Provisional application No. 62/454,392, filed on Feb. 3, 2017.

(51) Int. Cl. F04D 29/42; F04D 13/08; F04D 15/02; E03F 5/22; B63B 29/14; G01F 23/263; F04D 13/00

(52) U.S. Cl. CPC F04D 29/426; F04D 13/08; F04D 15/0281; E03F 5/22; F05D 2250/181; G01F 23/263; F04D 13/00; F04D 15/0218; B63B 29/14

(57) ABSTRACT

A pump features a liquid sensing device (LSD) in combination with a housing. The LSD senses the level of a liquid collecting outside the pump and turns the pump on/off for pumping the liquid. The housing includes a housing wall to contain the LSD. The housing wall has an outside wall surface with an outside sensing surface. The housing includes an inside mounting structure to mount the LSD inside the housing in relation to the outside sensing surface. The outside sensing surface has ribs extending or projecting outwardly away from the outside wall surface in order to prevent an object from being stuck on the outside sensing surface, and allow the LSD to sense the level of the liquid collecting outside the pump and touching the outside sensing surface, reducing a malfunction of the pump due to the object contacting the outside sensing surface.

### CROSS-REFERENCE TO RELATED APPLICATIONS

This application claims benefit to provisional patent application Ser. No. 62/454,392 (911-017.049-1//M-RLE-X0024), filed 3 Feb. 2017, which is incorporated by reference in their entirety.

### BACKGROUND OF THE INVENTION

### 1. Field of Invention

The present invention relates to a pump; and more particularly to a bilge pump.

### 2. Description of Related Art

In a typical centrifugal pump; fluid is accelerated through centrifugal forces exerted on it by an impeller which are used to transmit energy to the fluid being pumped. The pump may be controlled by a system automated using a capacitive sensing device. On the bottom of the pump, an impeller is located and protected against debris in the fluid by a strainer that will help to prevent some large particulates from getting stuck on the impeller and impede the rotation of the motor. The capacitive sensing device is integrated on a printed circuit board (PCB) that is programmed to control the function of the pumping unit. The sensor basically senses the presence of water and turns the pumping unit on to evacuate the water, e.g., on bilge and shower drain systems, once that water is down to a certain remnant level the PCB will automatic turn the pump off.

The assignee of the present application manufacturers and markets bilge pumps for the marine industry. Pumps used in this application are usually centrifugal type driven by a permanent magnet DC motor. These pumps feature an inlet and a discharge from which a hose connection is attached for routing of the discharge water out of the boat or vessel. Most of these pumps are controlled either manually by means of a panel mounted toggle switch or an automatic level switch. This level switch activates the pump motor when it senses the presence of water around the pump. Level switches usually are of the float type with dry contacts or an electronic sensor type. The switch can be a separate device or can be integral to the pump itself.

The environments in which the pumps operate usually contain debris in varying amounts. By way of example, the debris/contaminants may consist of oils, paper or cloth remnants from cleaning towels or other organic matter. These contaminants work to inhibit proper operation of the sensing device. Debris can sometimes adhere to the sensing surface, thereby causing false sensing signals where secondary failure modes can occur.

### SUMMARY OF THE INVENTION

### The Basic Invention

In summary, the new pump designs features a geometry designed to inhibit the adhesion of debris on the sensing surface. By way of example, the geometry may include a series of ribs placed to decrease adhesion surface area. The theory is that if debris will not stick, this will allow the sensor to function as designed.

In operation, the pumping unit according to the present invention improves the sensing effectiveness by changing the geometric design when compared to the known pumping units. By way of example, adding ribs at the sensing area will restrict towels and other objects from being in touch with the sensor area and prevent the pump from falsely sensing when no water is around to be pumped. In addition, these new ribs will be improving the structural design for a better heat resistance, preventing the deformation when the unit is under thermal stress environment.

### Specific Embodiment

According to some embodiments, the present invention may take the form of a pump featuring a new and unique combination of a liquid sensing device and a housing or pump body.

The liquid sensing device may be configured to sense the level of a liquid collecting outside the pump and turn the pump on/off for pumping the liquid, e.g., based upon the liquid level sensed.

The housing or pump body may include a housing wall configured to contain the liquid sensing device. The housing wall has an outside wall surface with an outside sensing surface. The liquid sensing device may be arranged or mounted inside the housing in relation to the outside sensing surface. The outside sensing surface may include ribs configured to extent or project outwardly away from the outside wall surface in order to prevent an object (such as a towel or rag), e.g., having a density different than the liquid density, from being stuck on the outside sensing surface, and allow the liquid sensing device to sense the level of the liquid collecting outside the pump and touching the outside sensing surface, so as to reduce a malfunction of the pump due to the object contacting the outside sensing surface.

According to some embodiments, the pump may also include one or more of the following features:

The outside sensing surface may be a flat surface, and the ribs may be arranged on and project from the flat surface.

The ribs may be arranged on the flat surface and dimensioned so that there is a space in-between adjacent ribs to receive the liquid between adjacent ribs when the object is stuck on, or in contact with, the ribs.

The ribs may be arranged on the outside sensing surface vertically or horizontally in relation to the pump axis.

The ribs may be symmetrically arranged on the outside sensing surface.

The ribs may include a shorter middle rib and longer outer ribs.

The ribs may be configured to provide heat resistance and structural rigidity to prevent deformation of the outside wall surface from thermal stress.

The liquid sensing device may be a capacitive sensing device, e.g., such as a printed circuit board having a capacitive sensing device.

The pump may be, or take the form of, one of the following:
a bilge pump for configuring in, and pumping the liquid from, a hull of a vessel, or
a sump pump for configuring in, and pumping the liquid from, a sump, or
a shower drain pump for configuring in, and pumping the liquid from, a shower drain.

The liquid sensing device may include a high liquid level sensor configured to sense a high liquid level and turn the pump ON, and includes a low liquid level sensor configured to sense a low liquid level and turn the pump OFF.

In effect, the new geometric ribs configured on the liquid sensing areas help to prevent objects from being stuck on the sensing surface and as a consequence avoid the malfunction of the pumping unit. These new ribs form a physical perimeter around the sensor, e.g., that avoid or prevent other object different than a liquid density to be in touch with the sensor. By way of example, these ribs may be located on a planar surface perpendicular to bottom of the pump and right at the back side of the pump, e.g., at the opposite side of the water outlet.

### BRIEF DESCRIPTION OF THE DRAWING

The drawing includes FIGS. 1-5D, which are not necessarily drawn to scale, as follows:

FIG. 1 shows a perspective view of a computer rendition of a bilge pump, according to some embodiments of the present invention.

FIG. 2 shows an exploded view of a computer rendition of a bilge pump, according to some embodiments of the present invention.

FIG. 3 shows a partial cutaway view of a computer rendition of a bilge pump, according to some embodiments of the present invention.

FIG. 4A shows a perspective side view a bilge pump, according to some embodiments of the present invention.

FIG. 4B shows a back view the bilge pump in FIG. 4A.

FIG. 4C shows a perspective bottom view the bilge pump in FIG. 4A.

FIG. 4D shows a perspective top front view the bilge pump in FIG. 4A.

FIG. 5A shows a perspective side view a bilge pump, according to some embodiments of the present invention.

FIG. 5B shows a back view the bilge pump in FIG. 5A.

FIG. 5C shows a perspective bottom view the bilge pump in FIG. 5A.

FIG. 5D shows a perspective top front view the bilge pump in FIG. 5A.

In the drawing, every element is not labeled with every reference no. and lead line to reduce clutter in the drawing as a whole.

### DETAILED DESCRIPTION OF BEST MODE OF THE INVENTION

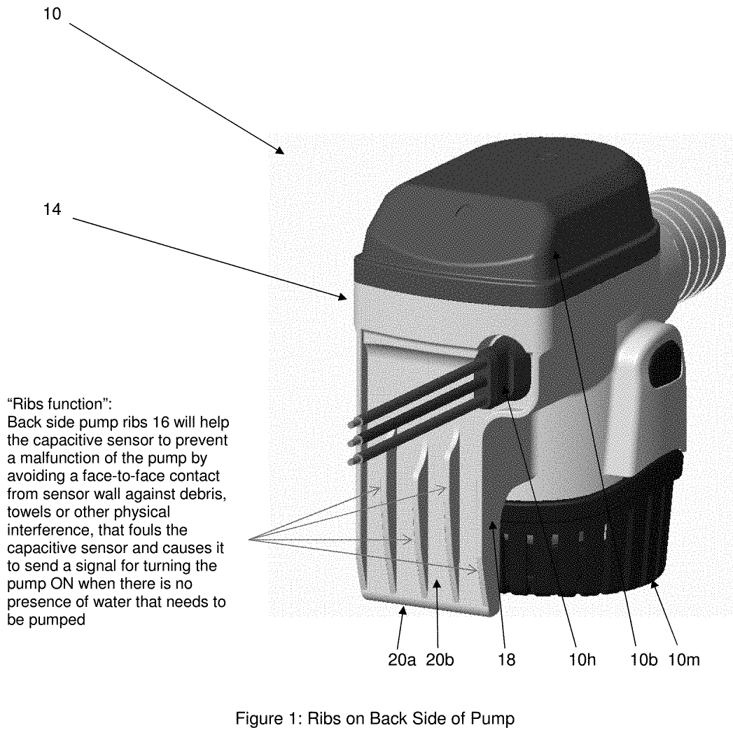

### FIGS. 1-3

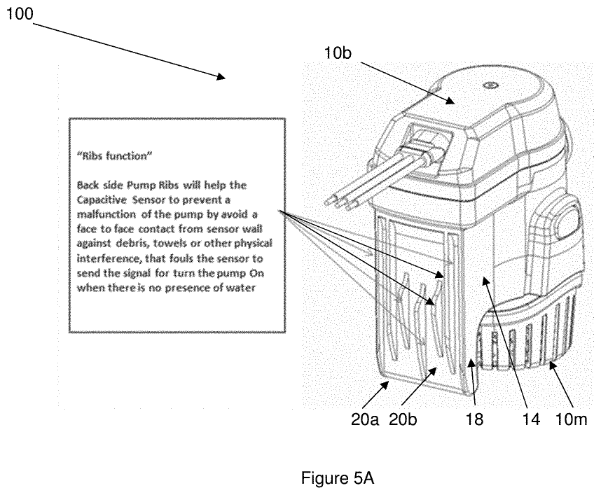

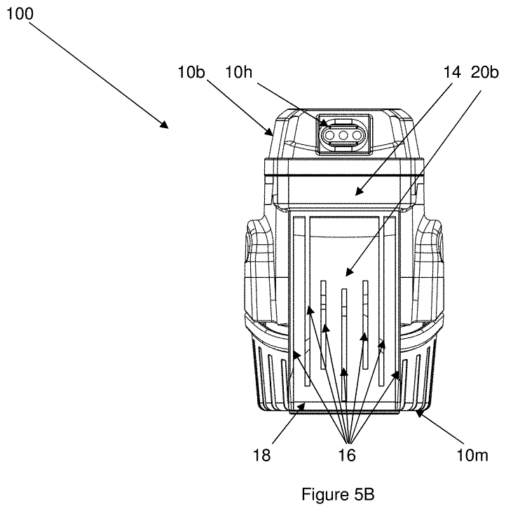

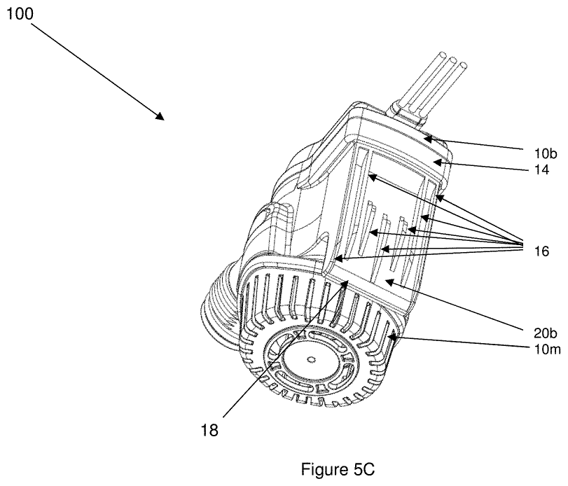

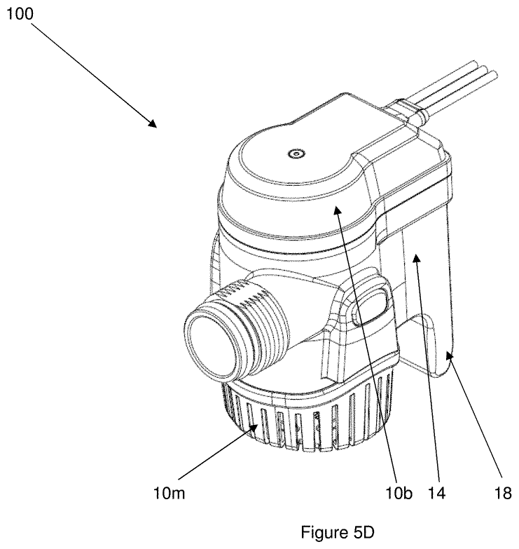

By way of example, and according to some embodiments of the present invention, FIGS. 1 thru 3 shows a pump generally indicated as 10 (FIGS. 1-4D), 100 (FIGS. 5A-5D) featuring a new and unique combination of a liquid sensing device 12 and a pump body or housing 14.

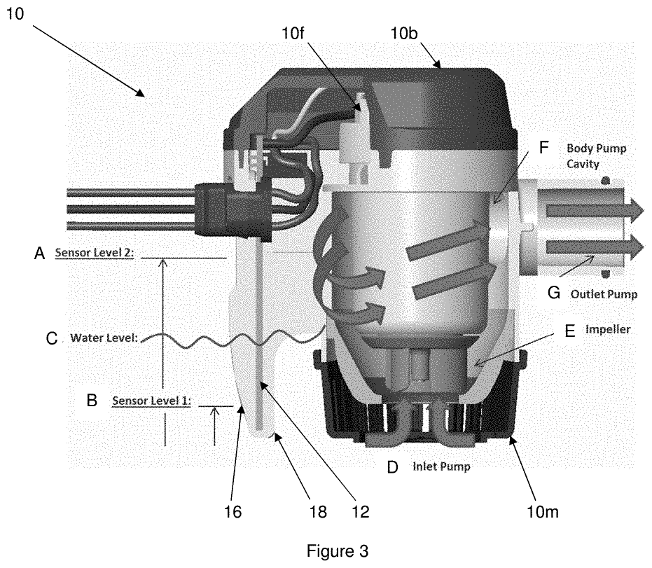

As shown in FIGS. 1 and 3, the pump body or housing 14 may be configured with some arrangement of back side pump ribs 16 that help the liquid sensing device 12 to prevent a malfunction of the pump 10 by avoiding face-to-face contact between an outside housing wall of the pump body or housing 14 and some debris in the liquid or fluid being pumped, e.g., such as a wet towel or other physical interference, that may foul the liquid sensing device 12 and cause it to send a signal for turning the pump 10 ON when there is no presence of water that needs to be pumped. For example, if a wet towel is stuck on or against the outside housing wall, and there is no fluid to be pumped, the liquid sensing device 12 may sense the liquid in the towel and send the signal for turning the pump 10 ON. (The pump may also stay ON, which can reduce the pump life, drain the battery of the boat or vessel, and cause other undesirable outcomes as well.)

The liquid sensing device 12 may be configured, mounted or arranged in a back part generally indicated as 18 of the housing 14.

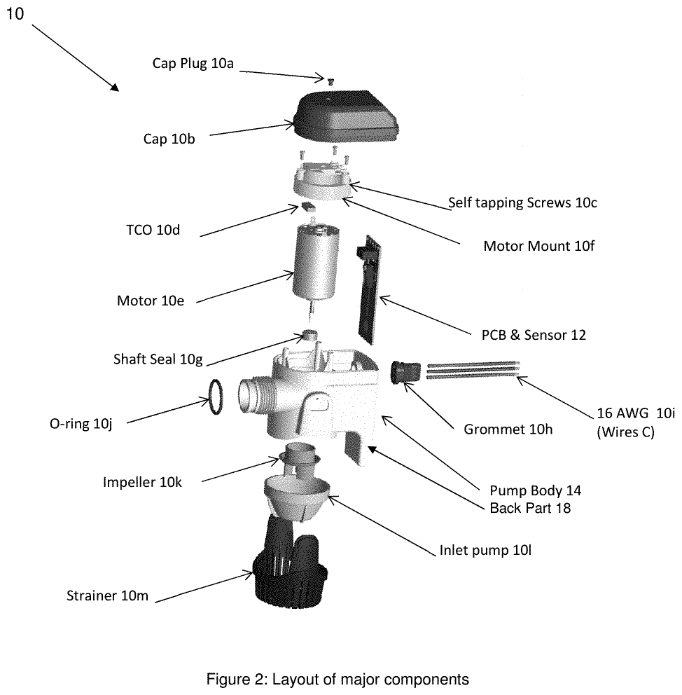

As shown in FIG. 2, and by way of example, in addition to the liquid sensing device 12 and the pump body or housing 14, the major components of the pump 10 may also include a cap plug 10a, a cap 10b, a self tapping screws 10c, a thermal cutoff (TCO) 10d, a motor 10e, a motor mount 10f, a shaft seal 10g, a grommet 10h, wires 10i, an O-ring 10j, an impeller 10k, an inlet pump 10l and a strainer 10m.

### The Level Sensing Device 12

The liquid sensing device 12 may be configured to sense the level of a liquid collecting outside the pump 10 and turn the pump 10 ON/OFF for pumping the liquid. As shown in FIGS. 1 and 3, and by way of example, the liquid sensing device 12 may take the form of a printed circuit board (PCB) and sensor. The PCB may be configured with a capacitive sensing device. Printed circuit boards having capacitive sensing devices are known in the art, and the scope of the invention is not intended to be limited to any particular type or kind thereof either now known or later developed in the art. The scope of the invention is also not intended to be limited to any particular type or kind of liquid sensing device either now known or later developed in the art, and may include other types or kinds of liquid sensing devices other than printed circuit boards having capacitive sensing devices.

### Normal Operation Cycle

By way of example, consistent with that shown in FIG. 3, the pump sensor 12 will determine the pump function ON/OFF by two predefined level sensor represented by bullets labeled A and B. For example, when the water level (bullet C) goes up to a sensor level 2 (bullet A), the sensor 12 will send a signal to the motor 10e and turn the pump 10 ON and make the impeller 10k rotate (bullet E), then water will be pulled by a centrifugal force of the impeller 10k from the inlet pump 10l (bullet 4) to be carried up by a centrifugal motion via and through the pump body cavity (bullet 6) and out the pump outlet (Bullet 7), so as to evacuate all water from the bilge until the water level (Bullet 3) goes down to the sensor level 1 (bullet 2), and then the sensor 12 will send the signal to turn the pump 10 OFF to complete the cycle.

### Pump Intelligence

By way of example, the pump sensor 12 may include built-in programming that can sense when the pump 10 is running, but not pumping water to protect the pump, as well as the vessel and the vessel's batteries in which it is being used. By way of example, in some implementations if debris fouls the sensor 12 or the pump 10 becomes air-bound, then the PCB may be configured to stop the pump from running, e.g., and begin to check periodically for water entry (such as every 2½ minutes) . Once the debris is removed, the pump 10 may be configured to revert to normal operation, e.g., by turning ON when the water reaches approximately 2½″ (Sensor Level 2 (FIG. 2)) and by shutting OFF the water reaches approximately ⅝″ (Sensor Level 1).

### The Housing 14

The housing 14 may include a housing wall 20 configured to contain the liquid sensing device 12. The housing wall 20 may include an outside wall surface 20a with an outside sensing surface 20b. The liquid sensing device 12 inside the housing 14 is mounted in relation to the outside sensing surface 20b. The outside sensing surface 20b may include the ribs 16 configured to extent or project outwardly away from the outside wall surface 20a, in order to prevent an object (e.g., having a density different than the liquid density) from being stuck on the outside sensing surface 20b, and allow the liquid sensing device 12 to sense the level of the liquid collecting outside the pump 10 and touching the outside sensing surface 20b, so as to reduce a malfunction of the pump 10 due to the object contacting the outside sensing surface 20b.

The outside sensing surface 20b may be a flat surface, and the ribs 16 may be arranged on and project from the flat surface. The ribs 16 may be arranged on the flat surface and dimensioned so that there is a space to receive the liquid between adjacent ribs when the object is stuck on, or in contact with, the ribs 16.

The ribs 16 may be configured to provide heat resistance and structural rigidity to prevent deformation of the outside wall surface 20a from thermal stress.

In effect, the new geometric ribs 16 on the sensing areas help to prevent objects from being stuck on the sensing surface and as a consequence avoid the malfunction of the pumping unit. These new ribs form a physical perimeter around the sensor that avoid other object, e.g., including other objects different than a liquid density, to be in touch with the sensor surface 20b. By way of example, these ribs 16 are located on the planar surface perpendicular to bottom of the pump and right at the back side of the pump, e.g., at the opposite side of the water outlet, consistent with that shown in FIGS. 1 thru 5D of the drawing.

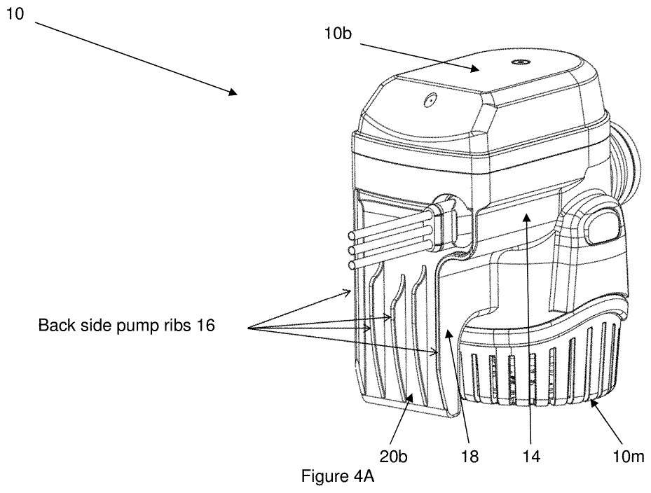

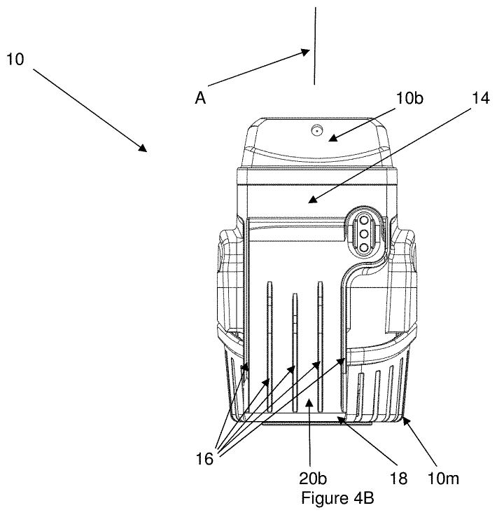

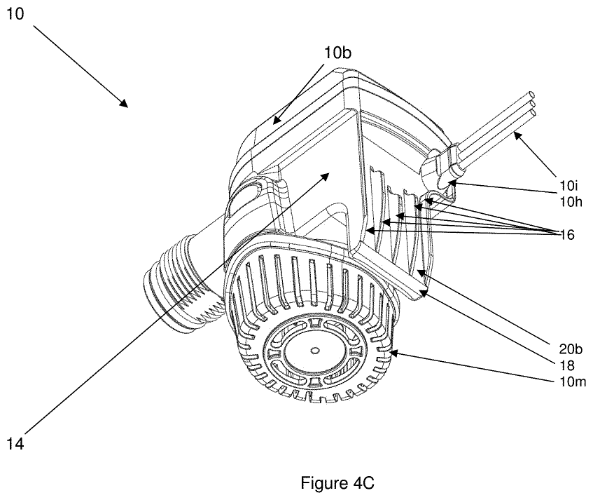

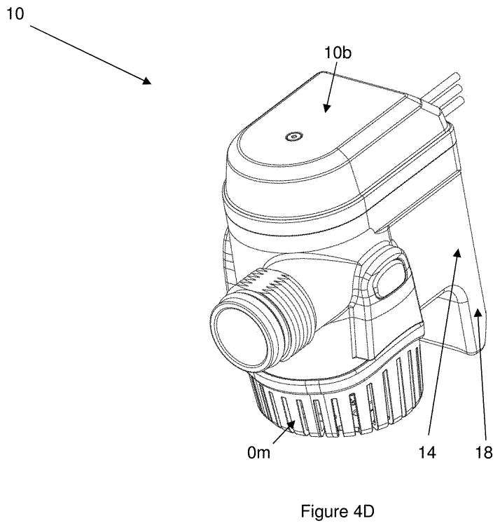

### FIGS. 4A Thru 4D and 5A Thru 5D

FIGS. 4A thru 4D show an embodiment of a pump 10 of the present invention, e.g., having five (5) ribs 16.

In comparison, FIGS. 5A thru 5D show an embodiment of a pump 100 of the present invention, e.g., having seven (7) ribs 16.

As shown, the ribs 16 may be arranged on the outside sensing surface 20b vertically in relation to the pump axis A (FIG. 4B), as well as horizontally in relation to the pump axis; the ribs 16 may be symmetrically arranged on the outside sensing surface; or the ribs may include a shorter middle rib and longer outer ribs. Moreover, and by way of example, the ribs 16 may be configured with a contour and a dimension, e.g., consistent with that shown in the drawing.

However, the scope of the invention is not intended to be limited to the number of ribs 16, the placement/configuration of the ribs 16, the orientation (e.g., vertical or horizontal) of the ribs 16, the dimension of the ribs 16, etc.; and embodiments are envisioned, and the scope of the invention is intended to include, implementations having a different number of ribs, a different placement/configuration of the ribs, a different orientation (e.g., vertical or horizontal) of the ribs, a different dimension of the ribs, etc., than that shown and described herein.

### Possible Applications

Possible applications include:

A bilge pump computerized with the sensor 12 included therein, capable to sense predefined water level and to operate depending on sensor input to turn the pump ON and OFF to evacuate the water from boat bilges. This pump is designed to be include in a system with or without bilge float switch and maintain same functionality of this pump.

### The Scope of the Invention

While the invention has been described with reference to an exemplary embodiment, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

1-14. (canceled)

15. A pump (10) comprising:
a liquid sensing device (12) configured to sense the level of a liquid collecting outside the pump (10) and turn the pump (10) on/off for pumping the liquid; and
a housing (14) having a housing wall (20 configured to contain the liquid sensing device (12), the housing wall (20) having an outside wall surface (20a) with an outside sensing surface (20b), the liquid sensing device (12) being arranged or mounted inside the housing (14) in relation to the outside sensing surface (20b), the outside sensing surface (20b) having ribs (16) configured to extend or project outwardly away from the outside wall surface (20a), in order to prevent an object from being stuck on the outside sensing surface (20b), and allow the liquid sensing device (12) to sense the level of the liquid collecting outside the pump (10) and touching the outside sensing surface (20b), so as to reduce a malfunction of the pump (10) due to the object contacting the outside sensing surface (20b), characterized in, that the liquid sensing device (12) is comprised in a pump (10), and in, that the outside sensing surface (20b) is a flat surface, and the ribs (16) are arranged on and project from the flat surface.

16. A pump according to claim 15, wherein the ribs (16) are arranged on the flat surface and dimensioned so that there is a space to receive the liquid between adjacent ribs (16) when the object is stuck on, or in contact with, the ribs (16).

17. A pump according to claim 15, wherein the liquid sensing device (12) is a capacitive sensing device.

18. A pump according to claim 15, wherein the liquid sensing device (12) is a printed circuit board having a capacitive sensing device.

19. A pump according to claim 15, wherein the ribs (16) are configured to provide heat resistance and structural rigidity to prevent deformation of the outside wall surface (20a) from thermal stress.

20. A pump according to claim 15, wherein the ribs (16) include five (5) ribs.

21. A pump according to claim 15, wherein the ribs (16) are arranged vertically in relation to the pump axis.

22. A pump according to claim 15, wherein the ribs (16) are arranged horizontally in relation to the pump axis.

23. A pump according to claim 15, wherein the ribs (16) are symmetrically arranged on the outside sensing surface (20b).

24. A pump according to claim 15, wherein the ribs (16) include a shorter middle rib (16) and longer outer ribs (16).

25. A pump according to claim 15, wherein the ribs (16) include seven (7) ribs.

26. A pump according to claim 15, wherein the pump (10) is
a bilge pump for configuring in, and pumping the liquid from, a hull of a vessel, or
a sump pump for configuring in, and pumping the liquid from, a sump, or
a shower drain pump for configuring in, and pumping the liquid from, a shower drain.

27. A pump according to claim 15, wherein the liquid sensing device (12) includes a high liquid level sensor configured to sense a high liquid level and turn the pump (10) ON, and includes a low liquid level sensor configured to sense a low liquid level and turn the pump (10) OFF.
